(19) United States
(12) Patent Application Publication
(10) Pub. No.: US 2024/0081318 A1
(43) Pub. Date: Mar. 14, 2024

(54) Hunting Stand Concealing System and Method

(71) Applicant: Jesse Murphy, Binghamton, NY (US)

(72) Inventor: Jesse Murphy, Binghamton, NY (US)

(21) Appl. No.: 17/944,155

(22) Filed: Sep. 13, 2022

(51) Int. Cl. A01M 31/02

(52) U.S. Cl. CPC A01M 31/025

(57) ABSTRACT

A hunting stand concealing system and method for camouflaging tubular elements of a hunting stand includes a tube having a perimeter wall. The perimeter wall has an upper end and a lower end with each end being open. The perimeter wall extends along a cavity defining a space for holding a tubular element of a hunting stand. Additionally, the perimeter wall has an elongated slit extending therethrough and through the upper and lower ends to allow the tubular element to pass through the perimeter wall and into the cavity. The perimeter wall has a plurality of notches extending therethrough and is aligned with the slit. Furthermore, the tube is made of a flexible material.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to hunting stand concealing device and more particularly pertains to a new hunting stand concealing device for camouflaging tubular elements of a hunting stand.

### (2) Description of Related Art Including Information Disclosed Under 37 CFR 1.97 and 1.98

The prior art relates to hunting stand concealing devices. The prior art includes a variety of hunting stand concealing devices configured for camouflaging the hunting stand among a surround environment. Known prior art lacks a hunting stand concealing device configured for camouflaging tubular elements of a hunting stand including enwrapping tubes about the ladder and railing of the hunting stand.

### BRIEF SUMMARY OF THE INVENTION

An embodiment of the disclosure meets the needs presented above by generally comprising a tube including a perimeter wall having an upper end and a lower end with each being open. The perimeter wall extends about a cavity defining a space for receiving tubular elements of a hunting stand. Additionally, the perimeter wall has an elongated slit extending therethrough and through the upper and lower ends to allow the tubular elements to pass through the perimeter wall and into the cavity. The perimeter wall has a plurality of notches extending therethrough and is aligned with the slit. Furthermore, the tube is comprised of a flexible material.

Another embodiment of the disclosure comprises a method including a step of inserting a tubular element of a hunting stand through an elongated slit of a perimeter wall of a tube and nesting the tubular element of the hunting stand within a cavity of the tube prior to positioning secondary elements of the tubular element within a respective one of a plurality of notches of the perimeter wall.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front isometric view of a hunting stand concealing system and method according to an embodiment of the disclosure.

FIG. 2 is a front isometric view of an embodiment of the disclosure.

FIG. 3 is a bottom view of an embodiment of the disclosure.

FIG. 4 is a cross-sectional view of an embodiment of the disclosure taken from FIG. 3 of Line 4-4.

FIG. 5 is an in-use view of an embodiment of the disclosure.

FIG. 6 is a front view of an alternative embodiment of the disclosure.

FIG. 7 is an in-use view of an embodiment of the disclosure.

### DETAILED DESCRIPTION OF THE INVENTION

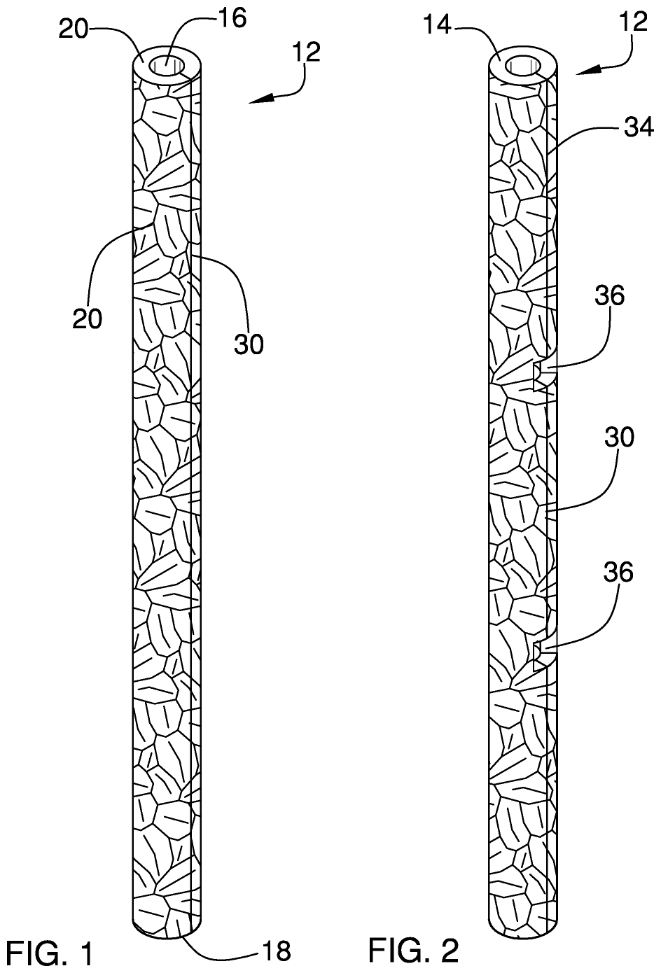

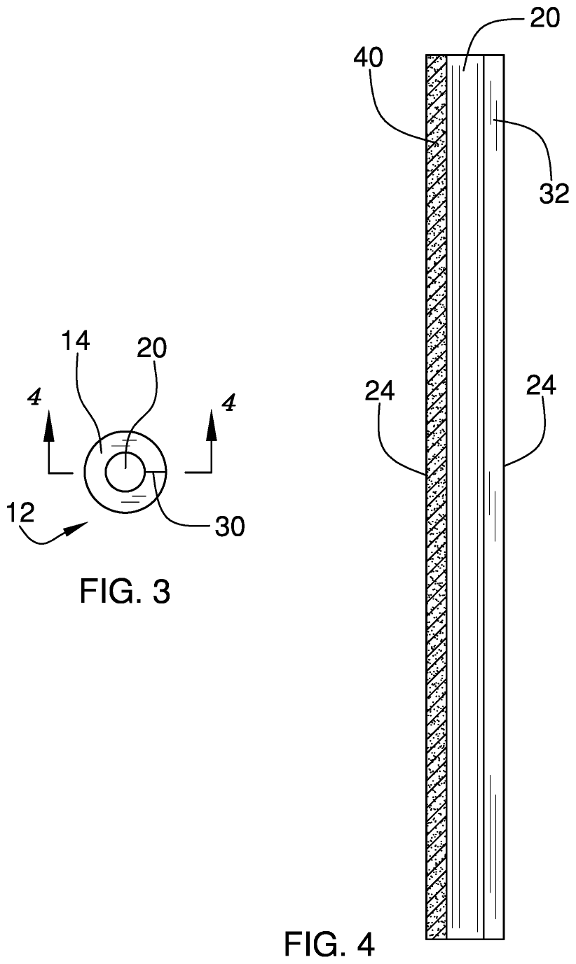

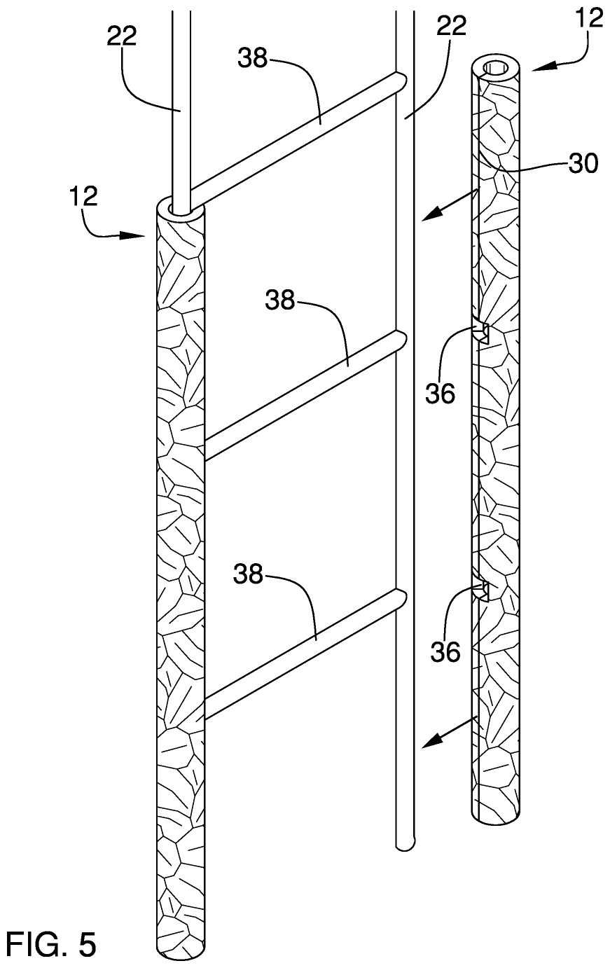

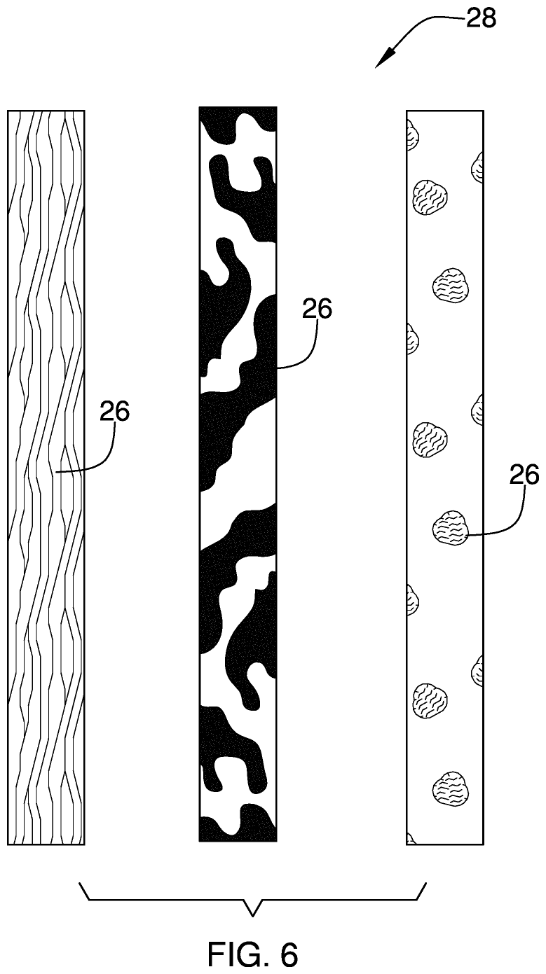

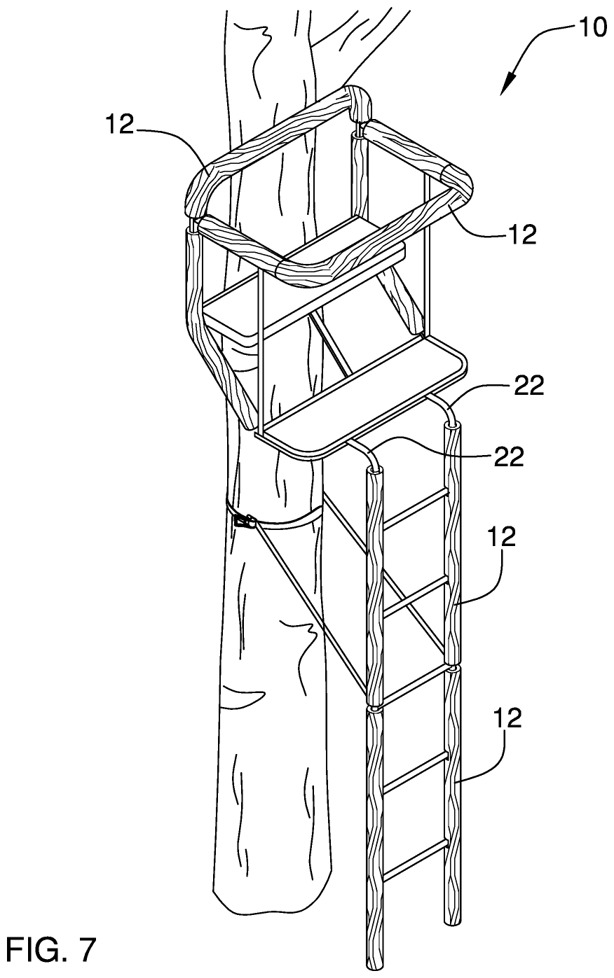

With reference now to the drawings, and in particular to FIGS. 1 through 7 thereof, a new hunting stand concealing device embodying the principles and concepts of an embodiment of the disclosure and generally designated by the reference numeral 10 will be described.

As best illustrated in FIGS. 1 through 7, the hunting stand concealing system 10 and method generally comprises a tube 12 including a perimeter wall 14 having an upper end 16 and a lower end 18. Each end of the perimeter wall 14 is open. The perimeter wall 14 extends about a cavity 20 defining a space for receiving a tubular element 22 of a hunting stand. The perimeter wall 14 has an outer surface 24 having camouflage indicia 26 thereon for camouflaging the tubular element 22 of the hunting stand. The camouflage indicia 26 includes a variety of designs 28 for blending within various surroundings such as trees and snow. The camouflage indicia 26 conceals the uniform color from the tubular element 22 of the hunting stand wherein reducing visual detection from animals.

The perimeter wall 14 has an elongated slit 30 extending therethrough and through the upper 16 and lower 18 ends to allow the tubular element 22 to pass through the perimeter wall 14 and into the cavity 20. The slit 30 includes a pair of surfaces 32 positioned from the outer surface 24 to the cavity 20 of the tube 12. The pair of surfaces 32 is abutting each other and is biased towards each other to define a closed position 34. Pulling away each of the surfaces 32 from each other to define an open position of the slit 30 and expose the cavity 20 to allow the tubular element 22 of the hunting stand to be nested within the cavity 20.

Furthermore, the perimeter wall 14 has a plurality of notches 36 extending therethrough and is aligned with the slit 30. The notches 36 are spaced from each other and are configured to receive secondary elements 38 attached to the tubular element 22. At least some of the second elements 38 comprise steps of a ladder of the hunting stand. The plurality of notches 36 prevent the secondary elements 38 from being lodged between the pair of surfaces 32 of the slit 30 wherein facilitate in securing the tube 12 upon the tubular element 22 of the hunting stand.

The tube 12 is comprised of a flexible material 40 being resiliently flexible. The tube 12 is bendable for securing about curvatures and corners of the tubular element 22 of the hunting stand. The flexible material 40 comprises a foamed elastomer being lightweight and easily transportable by a range of users. The flexible properties of the tube 12 facilitate in opening the pair of surfaces 32 of the slit 30 prior to inserting the tubular element 22 within the cavity 20 of the tube 12.

In use, the user inserts the tubular element 22 of the hunting stand through the elongated slit 30 of the perimeter wall 14 of the tube 12 by pulling the pair of surfaces 32 of the slit 30 apart. The tubular element 22 of the hunting stand nests within the cavity 20 of the tube 12 prior to releasing the pair of surfaces 32 of the slit 30 wherein forming the slit 30 back to the closed position 34. In addition, the user positions the secondary elements 38 of the tubular element 22 within a respective one of a plurality of notches 36 of the perimeter wall 14.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A hunting stand concealing system configured for camouflaging a hunting stand, the hunting stand concealing system comprising:
a tube including a perimeter wall having an upper end and a lower end each being open, the perimeter wall extending about a cavity, the cavity defining a space for receiving tubular elements of a hunting stand;
the perimeter wall having an elongated slit extending therethrough and through the upper and lower ends to allow the tubular elements to pass through the perimeter wall and into the cavity;
the perimeter wall having a plurality of notches extending therethrough and being aligned with the slit; and
the tube being comprised of a flexible material.

2. The hunting stand concealing system of claim 1, further comprising the perimeter wall having an outer surface having camouflage indicia thereon for camouflaging the tubular elements of the hunting stand.

3. The hunting stand concealing system of claim 1, further comprising the slit including a pair of surfaces positioned from the exterior surface to the cavity of the tube.

4. The hunting stand concealing system of claim 3, further comprising the pair of surfaces being abutting each other.

5. The hunting stand concealing system of claim 4, further comprising the pair of surfaces being biased towards each other to define a closed position.

6. The hunting stand concealing system of claim 1, further comprising the notches being spaced from each other and being configured to receive secondary elements attached to the tubular elements.

7. The hunting stand concealing system of claim 6, further comprising at least some of the second elements comprising steps of a ladder of the hunting stand.

8. The hunting stand concealing system of claim 1, further comprising the flexible material being resiliently flexible.

9. The hunting stand concealing system of claim 8, further comprising the flexible material comprising a foamed elastomer.

10. A hunting stand concealing system configured for camouflaging a hunting stand, the hunting stand concealing system comprising:
a tube including a perimeter wall having an upper end and a lower end each being open, the perimeter wall extending about a cavity, the cavity defining a space for receiving tubular elements of a hunting stand, the perimeter wall having an outer surface having camouflage indicia thereon for camouflaging the tubular elements of the hunting stand;
the perimeter wall having an elongated slit extending therethrough and through the upper and lower ends to allow the tubular elements to pass through the perimeter wall and into the cavity, the slit including a pair of surfaces positioned from the exterior surface to the cavity of the tube, the pair of surfaces being abutting each other, the pair of surfaces being biased towards each other to define a closed position;
the perimeter wall having a plurality of notches extending therethrough and being aligned with the slit, the notches being spaced from each other and being configured to receive secondary elements attached to the tubular elements, at least some of the second elements comprising steps of a ladder of the hunting stand; and
the tube being comprised of a flexible material, the flexible material being resiliently flexible, the flexible material comprising a foamed elastomer.

11. A method for camouflaging a hunting stand with a concealing system, the method including a step of:
inserting a tubular element of a hunting stand through an elongated slit of a perimeter wall of a tube;
nesting the tubular element of the hunting stand within a cavity of the tube; and
positioning secondary elements of the tubular element within a respective one of a plurality of notches of the perimeter wall.
